(19) United States
(12) Patent Application Publication
(10) Pub. No.: US 2012/0076582 A1
(43) Pub. Date: Mar. 29, 2012

(54) Cleaning links for conveyor chain

(76) Inventors: Steve Jeffers, Newton, NC (US); David W. Nolan, University Place, WA (US)

(21) Appl. No.: 12/924,472

(22) Filed: Sep. 28, 2010

(51) Int. Cl. E01C 19/18; B65G 19/20

(52) U.S. Cl. 404/108; 198/851

(57) ABSTRACT

The outer link panel of one or more links carrying the scraper bars of a scraper-chain conveyor is replaced with a link panel having a projection extending from the chain to the guide channel wall. These projections then travel with the chain and clear the space between the chain and guide channel wall of spilled loose material lodged therein.

### RELATED APPLICATION

None

### U.S. GOVERNMENT INTEREST IN THE INVENTION

None

### BACKGROUND OF THE INVENTION

1. Field of the Invention

Scraper-chain conveyors adapted to carry hot asphalt, in particular the type having two endless loop link chains of the type known “as roller chains” with transverse scraper bars between. Where the transverse scraper bars urge the conveyed material along a supporting surface. These are sometimes called scraper-chain conveyors or drag-chain conveyors. In the presently described embodiment, the scraper-chain type conveyor has outwardly extending sweeps integral with some of the roller chain links wherein said sweeps clear pebbles, sand, and tar from the guide ways outside the central asphalt transport channel.

2. Description of the Prior Art

Asphalt surface roads are constructed by an asphalt laying machines of the type having a receiving hopper on the front end, a chain link conveyor assembly for moving the asphalt from the hopper to the back end of the machine, where a screw conveyor or equivalent mechanism distributes the asphalt transversely across the back end of the machine and dumps it onto a prepared roadbed. A screed then spreads and levels the asphalt to a constant depth and smooth surface. The asphalt thus placed is compacted by a following compacting machine which may be part of the spreader or an independent compactor machine. The result is a paved road surface which after suitable setting time for hardening, is ready to receive traffic.

The present art makes good roadways, but the machine suffers from small amounts of asphalt coated pebbles, sand, and tar getting into the channels between the outer roller chains and the up-turned edges of the slide pan (bottom pan) over which the scrapers push the asphalt along. This is leads to excessive wear on the heads of the chain link pins, and when the paving machine is retired for the night, the outer channels must be cleaned. If not, the hot tar cools and forms solid masses of pebbles, sand, and tar in the conveyor which must be chipped or burned out before the paving machine can be re-started. Failure to do so, often results in a broken paving machine.

The present invention is to fit at least one link, preferably many, on each side with outwardly extending sweeps to clear the spilled asphalt from the outer channels.

Four patents from the prior art utilize outward extensions on the chain links. While having similarities, none individually or in combination have all the characteristics of the present invention.

PN 2,766,979, “Cutter or Disintegrating Chain with Dirt Scraping Means”, by Alexander Caulder, is basically a large chain saw used in the coal mining industry, '979 shows a link chain with two projections extending outwardly. These projections are not part of a cleaning system, but are stabilizers to keep the chain upright.

There are several notable differences between Caulder's device and the present invention. In particular, the Caulder device is not a materials conveyor, it is a cutter in the general design of a chain saw and particularly adapted for cutting coal. It has a single chain riding in a narrow channel accommodating the only chain and the links are in bicycle chain configuration. The dirt scraping means is a transverse cut (17) in the bottom of the link (22), not extending outwardly, and cleans only the bottom of the channel.

If the Caulder cleaning means (17) were to be adapted for use in an asphalt conveyor, the slot (17) would quickly fill with gooey tar. Furthermore, bottom of link 22 would ride on a tar film which would harden and glue the link to the channel. Which, among other things, is what the present invention is to prevent.

Outwardly extending lip (14) is not a scraper, but a lever cooperating with channel liner 13 (FIG. 2) to keep the chain held in the channel for preventing the chain from tipping over. (text 2:58-67) The top bosses (16) extending inwardly and outwardly (FIG. 2) against the channel liner (13) also provide stability against overturning, and act as seals against larger particles entering the channel. Neither 15 or 14 clean the sides of the channel nor sweep any dirt out of the channel as do the sweeps of the present invention.

PN 4,505,379, “Scrapers for Scraper-Chain Conveyors”, by Helmitt Temme. Temme's scrapers of interest are the shaped and treated edges of the transverse bars between the chains. What appear in the figures as outward projections (“locking devices”) (17) from the links are the connectors to connect the product urging scraper bars (16) to the driving chains (15). The extent of the locking devices (17) beyond the chain line is not discussed, nor is any other purpose for them revealed. FIG. 1 shows them as not touching (thus not scraping) the guide way (14) walls.

Within the text, the words “scraper”, “scraping”, and derivatives are clearly always used in connection with the scraper bars, which are the focus of the patent. The phrase “scrapers for . . . ” in the title is more ambiguous, but surely is intended to mean the portions (24 & 26) of the scraper bars (16) dedicated to scraping either or both the top pans (12) or the closing pans (13) on the underside of the conveyor.

The text describes two embodiments of the locking device (17). FIG. 1 and the text at 2:33-41 describes them as passing through vertical loops of the chain. The nubs on the ends of the locking devices are not described, but seem to be for preventing the chain from slipping off the ends of the locking devices. The second embodiment is described at 2:45-50 (Col 2, lines 45-50) and is not illustrated in the figures. The locking devices are described as replacing a horizontal link and being attached to two vertical chain link loops. For the second embodiment, there would be no need for extended portions or nubs as shown in FIG. 1 depicting the first embodiment

Any other assertion about the operation and function of the locking device (17) is pure speculation.

Note that the Temme disclosure uses common loop chain, not the type having interdigitated side panels linked by pivot pins (roller chain) as described for the present invention. Note also that re-designing the Temme locking devices to accommodate the roller chains of the present invention would change the structure and mode of operation of the Temme locking devices. Such a revision would be outside the permissible modifications to assert a 103 rejection.

PN 5,280,833, “Turn Conveyor with Reduced Friction Feature” by Andre Robin. Robin's friction reducing feature is an add-on to conventional conveyors designed to carry boxes and bulk goods around corners. The conveyors he describes, both as prior art and as new are not suitable for moving loose material such as sand, gravel, or mixtures, and especially when such loose material is conglomerated with sticky liquids like asphalt. The edges of his conveyors are fitted with glides having very low coefficients of friction. The glides in some embodiments are projections extending outwardly from the glide body.

Robin's preferred projections are two sets of bars Robin calls “V shaped portions” or “plows”, arranged in a chevron pattern with the points in the center of the projections and facing forward. Robin asserts that the chevrons (“plows”) are adapted to remove debris from between the belt and frame (see 'abstract, 2:51-53, 4:64-5:5). While, the Robin “plows” might push the kind of debris expected from transporting boxes and bulky items, they would not work with gooey, sticky, viscous tar-sand-pebbles mixture. They would ride over and compact tar-sand, and would ride over pebbles stuck or dragging in the tar. The present invention overcomes this limitation by utilizing projecting cleaning bars of different configuration from those of Robin.

PN 7,600,632, “End Protector Link for a Conveyor Chain”, by William C. Hall. This disclosure teaches a retaining clip something like a D ring that slips over enlarged heads of the link pins. The retainer is U shaped in cross section and one side slips behind the link pins and the other side slides along the conveyor frame, trough, or track. The retainer/protector is not part of the link itself, and there is no teaching that the retainer cleans the conveyor guide trough, nor is there a teaching that the retainer clip reduces friction of the chain against the guide trough. Indeed, the clip is not capable of exerting much force against dirt and other debris in the guide trough without becoming disengaged from the link pins. Furthermore, being open on 3 sides and hollow, the interior of the protection clip will pack with fines, which in the case of asphalt and other hardening material, will make removal of the clip and links difficult if not impossible.

3. Objects of the Invention

The object of the invention is to provide a means for clearing the guide channels of an asphalt carrying conveyor of entrapped components of the asphalt, thereby preventing the entrapped asphalt from hardening and jamming the conveyor.

Another object of the invention is to reduce the wear on the roller chain link pivot pins by removing much of the grit that accumulates in the chain guide ways.

Another object of the invention is to have the clearing means simple and retrofit able to existing paving machines at reasonable cost.

Another object of the invention is to reduce wear on the link pins by preventing the pin-heads from rubbing against the channel walls or being abraded by accumulated sand and grit.

In accordance with these and other objectives of the invention, there is provided an improvement to a roller chain conveyor of the scraper-chain variety wherein bosses extending into the guide channels outboard from the chains to sweep said channels clear of spilled loose material.

### BRIEF SUMMARY OF THE INVENTION

Selected links of a roller chain conveyor adapted to move heated unconsolidated asphalt paving material are fitted with lateral extensions that both sweep away asphalt that has spilled out of the primary conveyor belt system and to provide separation of the chain links and the sides of the conveyor guide trough, often called the conveyor track.

The sweeps comprising a bar of steel are fixedly attached to selected links of the link chain, and extend outwardly to the proximity of the conveyor guide trough.

Thus any material spilling beyond the chain will be swept away and at the same time, the chain links will be held away from the trough edges, thereby preventing the heads of the link pins from rubbing and wearing away, thus extending the chain life. Field trials indicate an increase in conveyor life of more than double over the present art, plus the labor saved by not having to clean the outer guide channels.

### BRIEF DESCRIPTION OF THE FIGURES

FIG. 1 is a schematic an asphalt pavement laying machine. Details of many common parts have been omitted.

FIG. 2 is an isometric view of a typical link chain used in an asphalt laying paving machine.

FIG. 3 is a detailed head-on view of a the guide channels, chains, and cross-bar scraper-sweeps used in a typical scraper-chain type conveyor.

FIG. 4a is a view of the invention applied to a chain link.

FIG. 4b is the same link turned around.

FIG. 5 is an expanded view of the chain and guide channel end.

FIG. 6 shows an alternative cleaning sweep design

FIG. 7 shows an alternative chain design (bicycle chain style)

FIG. 8 shows an alternative chain design using flat sided links set at an angle

### TABLE OF IDENTIFIED DETAILS

1. Over-all view of a paving laying machine with non-essential components omitted.
2. Receiving hopper
3. Link chain conveyor
4. Distributor/Spreader
5. Screed bar
6. Scraper bars, cross-bars, primary sweeps
7. Guide channel, Conveyor bottom pan
8. Drag Chains
9. Scraper bar mounting tab on chain link
10. Channel space between chain and up-turned edges of the conveyor pan. Also “Outer channels”, “guide channels”, “guide ways”.
11. Cover over chain, hood
12. Link pins
13. Channel clearing bar
14. Link side panels
15. Up-turned edge of conveyor pan, “Guide or outer channel wall”

### DETAILED DESCRIPTION OF THE INVENTION

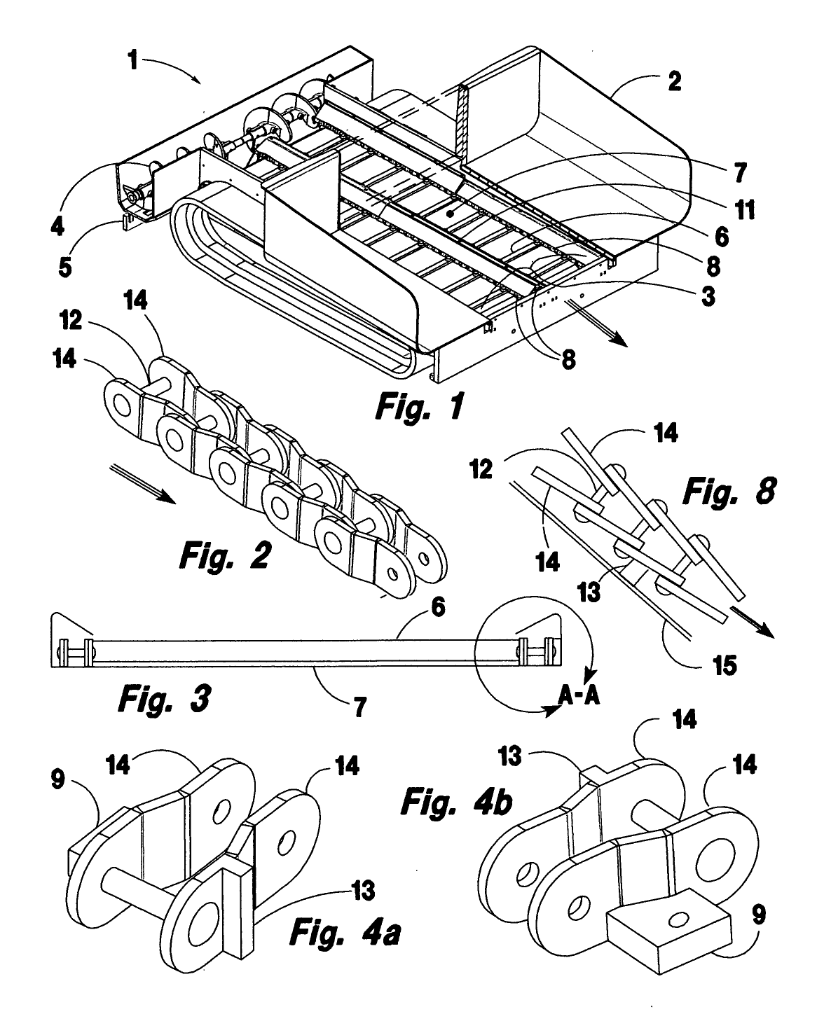

FIG. 1 shows the essential elements of an asphalt laying paving machine (1). These are: a hopper (2) for receiving, usually hot, unconsolidated asphaltic paving material from a truck or paving reclaiming/reconstituting machine, a conveyor means (3) for moving the unconsolidated paving material to the back of the paving layer (1) to a distributor (4) which spreads the paving material approximately evenly over the width of the roadway lane being paved, and a screed (5) for finishing the spreading and for leveling the unconsolidated paving material into a smooth, flat surface. All of this, loading, spreading, and smoothing, is done while in motion along the roadbed. The paving job is finished off with a following compactor (not shown) to consolidate the asphalt and give it a finished surface.

Referring to FIG. 1, the conveyor (3) comprises a pair of driving chains (8) connected to each end of cross-bars (6), sliding over the conveyor bottom pan (7). The cross-bars move from front to back and drag the paving material along the bottom pan from the hopper to the spreading components.

The driving chains (8) used in the conveyor of paving machines are of the type known as a “roller chain” of the form shown in either FIGS. 2, 7, and 8 with the design of FIG. 2 or 8 being strongly preferred, particularly that of FIG. 2. A roller chain link has two side plates (14) separated by a pins (12) through a hole in each end. Links are overlapped and attached together by a pin common to two adjacent links. Several links so connected form a strand that is very strong and very flexible in one plane, and somewhat stiff in the orthogonal plane. An actual roller may be inserted over the central portion of the pins to act as a rotating bearing and as a spreader to maintain separation of the side plates. Roller chains are driven by at least one sprocketed wheel wherein the roller pins nestle between the sprocket teeth in gear-like fashion and the side plates straddle the sprocket, giving stability to run on the sprocket. The design illustrated by FIG. 2 is characterized by the side plates being joggled to permit one end of each link to telescope within the co-operating end of the adjacent link. the design illustrated in FIG. 8 also telescopes but is comprised of essentially flat side plates. These can be punched out of flat stock, stamped, machined, or cast more easily than joggled side plates. The angled pins presents a distinct disadvantage for manufacturing and the FIG. 8 design is not as common as the design of FIG. 2. Telescoped links moving in the direction of small end first helps keep grit from entering into the pivoting joint and grinding the joint surfaces.

The illustration of FIG. 1 shows what appears to be two side by side conveyors. Multiple coordinated scraper units may be incorporated, however, there is always two outer roller chains on the edges of the moving assembly. These are the subjects of this disclosure. The center roller chain assembly may be two independent roller chains, a single strand chain common to both conveyors, or a composite chain made of multiple strands on common link pins.

FIG. 3 shows a typical cross-bar viewed along the conveying axis. Cross-bar (6) is attached on each end to a boss (9) on the inside side plate (14) of a chain link (8) by bolting or similar. The paving material is pushed along the bottom pan (7) by the movement of the cross-bars. The bottom pan is up-turned on its side edges (15) to form a channel (10) between the chain (8) and the up-turned sides (15). Even if the chains (8) and channels (10) are hooded (11), fine material such as sand, rock chips, pebbles, and tar find their way into the channels (10). This material builds up and the heads of the chain pins (12) rub against build-up and are ground away resulting in chain failure, and when cooled at the end of the shift, the build up hardens into a solid mass which prevents the chain from moving when the machine is re-started.

FIGS. 4a and 4b show the debris clearing bars or sweeps (13) attached to the outside panels (14) of some links, preferably to the links carrying the cross-bars. The cross bars (6) provide stability to resist twisting, overturning, and lateral movement of the clearing links.

The debris clearing bars, or sweeping bars, (13) in the clearance channel (10) comprise a projection extending outwardly from the outer link panel to the proximity of the up-turned edge of the bottom pan which is the outer wall of the clearance channel (10), and perpendicularly to the direction of travel from the proximity of the bottom to the proximity of the top of the link outer panel, whereby the projection sweeps paving material from said clearance channel, thereby preventing said paving material from abrading the roller chain or from hardening in the clearance channel.

The preferred, and tested, material for the sweeping bars (13) is steel, but other materials such as woods, plastics, filled plastics, ceramics, and micarta, may work well in various applications. In general, filled plastics are characterized as having the chemical properties of the plastic, and the mechanical properties of the filler material. Tungsten carbide, silicon carbide, and ferrites are in the family of ceramics and may be used as the material of the sweeps, or in powder or granular form as filler.

The preferred method of attaching the sweeps (13) to the link panels (14) is to construct the link plates with the bars formed integrally by forging, casting, or machining. However, this disclosure does not preclude other fastening methods such as brazing, welding, bolting, glueing, etc.

The sweeps (13) do wear against the residual grit in the channel (10), but are easily replaced. Much more easily replaced than all the link pins in a worn-out chain. It is known that sometimes softer materials withstand abrasion better than hard materials. That is why some softer materials are suggested.

### ALTERATIVE EMBODIMENTS AND VARIATIONS OF THE INVENTION

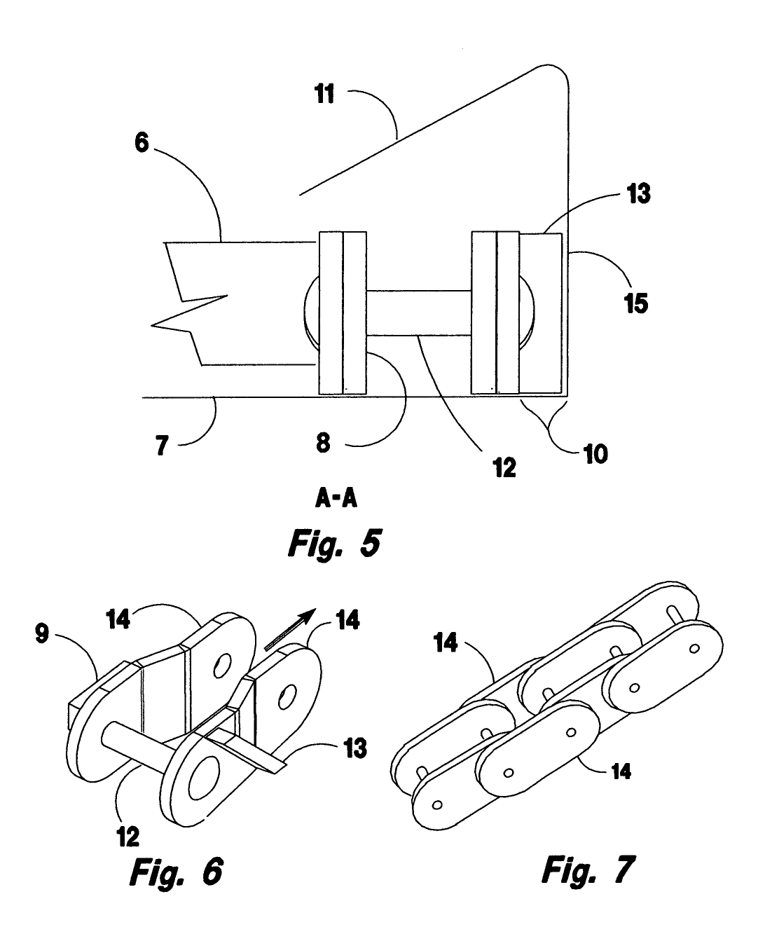

FIG. 5 illustrates a tilted back sweeping bar (13). The maximum amount of backward tilt is primarily controlled by the amount of space available on the face of the link side between the link-pins and the next link face. Back tilting provides three advantages, first, the bottom edge acts somewhat as a knife edge to cut under any tar-sand debris, second, the loosened debris will be agitated and rolled upward along the sweeping bar, thus reducing a tendency for packing at the front face of the sweeping bar, and third, the angling presents considerably more area to the grit for enhanced abrasion resistance and fastening strength.

Referring to FIG. 6, an alternative roller chain design using the concept usually found in bicycle chains is not suitable for use in a scraper-chain conveyor. In this type, the link faces are flat, and alternate inside-outside-inside-etc instead of being telescoped as shown in FIGS. 2 and 8. A bicycle type chain has a few advantages for other applications, but is at a significant disadvantage for scraper-chain use in that the chain links plow through the material being conveyed, forcing grit into the pivoting link ends. This same plowing through also lifts some of the conveyed material where it can fall between the side panels of the roller links.

The roller chain design shown in FIG. 2 can also use flat side panels of FIG. 7, only with the panels set at a dihedral angle instead of parallel. The adjacent links then fit together like those illustrated in FIG. 2. Obviously, the pin holes are drilled through the side plates at an angle to in alignment to receive the linking pin or the pins themselves are bent to be perpendicular to the side panels.

The sweep bar (13), may in some applications, be removably attached by various means such as T slots, bolting, pins through the plate secured by D rings, nuts, cotter pins, etc.

### HOW TO USE THE INVENTION

The outer link panel of one or more links carrying the scraper bars is replaced with a link panel having laterally extending projections adapted to extend from the chain to the guide channel wall. These projections then travel with the chain and clear the channel between the chain and guide channel wall of spilled loose material lodged therein. Wear on the projections is expected, and the outer link panels may be repeatedly replaced until the rest of the chain wears beyond its effective life.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

I claim:

1. A paving machine comprising in combination:
a. a scraper-chain conveyor having at least one endless driving roller chain, and a bottom pan having at least one up-turned edge as an outer wall, said bottom pan having a portion between said roller chain and said outer wall forming a clearance channel wherein paving material being transported may lodge, and
b. said roller chain comprising a plurality of links, each link having an inner and outer panel, the outer panel of at least one link further comprising a projection extending outwardly from said outer panel to the proximity of said outer wall, and from the proximity of the bottom to the proximity of the top of said outer panel, whereby said projection sweeps paving material from said clearance channel, thereby preventing said paving material from abrading the roller chain or from hardening in the clearance channel.

2. The paving machine of claim 1 where the link projection is oriented perpendicular to the direction of travel of the roller chain.

3. The paving machine of claim 1 where the link projection is oriented with the upper end trailing the bottom end as the roller chain moves.

4. The paving machine of claim 1 where said product is unconsolidated asphalt paving material.

5. The paving machine of claim 4 where said unconsolidated asphalt paving material is heated.

6. The paving machine of claim 1 having a leading first link and a following second link where the outer faces of the link side panels of the second link are pivotally connected to the inner faces of the link side panels of the first link, whereby as the roller chain moves through said paving material, the wider portion of the links trails the narrower portion of the links, thereby presenting a tapered profile to the paving material and where the pivot connection is shielded from paving material being pushed into the pivoting faces of the chain.

7. The paving machine of claim 6 where the link side panels further comprise inward joggles, thereby causing the leading end of the link to be narrower than the trailing end, permitting the narrower end of a link to slip within the wider end of the adjacent link.

8. The paving machine of claim 6 where the link side panels are oriented to form a dihedral angle, thereby causing the leading end of the link to be narrower than the trailing end, permitting the narrower end of a link to slip within the wider end of the adjacent link.

9. An asphalt paving machine comprising in combination:
a. a scraper chain conveyor having at least one scraper driving roller chain, and a guide channel, said guide channel having an outer wall, the space between said roller chain and said outer wall being a clearance channel wherein a portion of the asphalt paving material being transported may lodge, and
b. the outer panel of at least one link of said roller chain further comprising a projection extending outwardly from said outer panel to the proximity of the clearance channel outer wall, and from the proximity of the bottom to the proximity of the top of said outer panel, whereby said projection sweeps asphalt paving material from said clearance channel, thereby preventing said asphalt paving material from abrading the roller chain or from hardening in the clearance channel.

10. The paving machine of claim 9 where the link projection is oriented perpendicular to the direction of travel of the roller chain.

11. The paving machine of claim 9 where the link projection is angled from perpendicular where the upper end trails the bottom end as the roller chain moves.

12. The paving machine of claim 9 where said asphalt paving material is unconsolidated and heated.

13. The paving machine of claim 9 having a leading first link and a following second link where the outer faces of the link side panels of the second link are pivotally connected to the inner faces of the link side panels of the first link, whereby as the roller chain moves through said paving material, the wider portion of each links trails the narrower portion of each link, thereby presenting a tapered profile to the paving material and where the pivot connection is shielded from components of the paving material being pushed between the pivoting faces of the chain.

14. The paving machine of claim 13 where the link side panels further comprise inward joggles, thereby causing the leading end of the link to be narrower than the trailing end, permitting the narrower end of a link to slip within the wider end of the adjacent link.

15. The paving machine of claim 13 where the link side panels are oriented to form a dihedral angle, thereby causing the leading end of the link to be narrower than the trailing end, permitting the narrower end of a link to slip within the wider end of the adjacent link.

16. An asphalt laying machine comprising in combination:
a. a receiving receptacle for receiving a supply of unconsolidated asphalt paving material
b. means to distribute and place said asphalt onto a roadbed
c. a scraper-chain type conveyor to transport said asphalt from said receiving receptacle to said distribution means
d. said conveyor having at least two roller chains to urge cross bar scrapers forward, each said roller chain comprising a plurality of pivotally connected links, and
e. each link comprising first and second transversely spaced apart side panels each side panel having first and second longitudinally separated ends, and each end has an aperture therethrough, and wherein said first and second side panels comprise a link with first and second apertured ends, and
f. wherein said first apertured link end is wider than said second apertured link end, whereby said links are pivotally interconnected end to end having said first apertured end receiving said second apertured end with said apertures in alignment for receiving a connecting pin therethrough, thereby forming a set of links having flexibility in one plane, and
g. a bottom panel comprising a flat bottom and upturned sides forming a channeled tray for for receiving said roller chains and scraper bars between the roller chains, and
h. at least one roller chain link of at least one roller chain further comprising an outwardly extending projection extending from the outer side of said link to the vicinity of said channel upturned side and substantially from the bottom to the top of said link outer side, whereby
i. the moving chains urge the cross bars forward, the asphalt is likewise moved under the urging of said cross bars, and some asphalt material finds its way into an outside channel between said roller chain and said upturned side, wherein said outwardly extending extensions encounter said material and sweep it out of said outside channel.

17. The asphalt laying machine of claim 16 where:
said roller chain has links comprising first and second spaced apart side panels wherein each side panel has a first flat portion, a joggled portion, and a second flat portion said flat portions have apertures for receiving a linking pin, whereby said second flat portions are adapted to lie within the space between said first portions and said links are connected to each other by pins through the cooperating apertures in said first and second flat portions, thereby forming a set of links having flexibility in one plane.

18. The asphalt laying machine of claim 16 where:
said roller chain has links comprising two elongated approximately flat side panels, each side panel having an aperture near each end, and said side panels arranged in side by side relationship with a dihedral angle between them forming a link having first and second ends where the first end is wider than the second end, where the second end of one link cooperatively fits within the first end of an adjacent link with the apertures in alignment to receive a pin therethrough, wherein a plurality of said links arranged first end to second and interconnected by pins through said apertures comprise said roller chain.

19. The asphalt laying machine of claim 16, where:
said outwardly extending projections having a longer axis extending from the vicinity of said bottom panel to the vicinity of the top of said link and oriented perpendicularly to the direction of motion of said roller chain.

20. The asphalt laying machine of claim 16, where:
said outwardly extending projections has a longer axis having upper and lower ends, longer axis extends from the vicinity of said bottom panel to the vicinity of the top of said link and oriented to have the upper end trail the lower end when the roller chain is in motion.
